(19) United States
(12) Patent Application Publication
(10) Pub. No.: US 2008/0012257 A1
(43) Pub. Date: Jan. 17, 2008

(54) Portable bedside toileting storage system

(76) Inventor: Donna Emerson Cregg, Centerville, MA (US)

Correspondence Address: CHARLES G. CALL, 215 W. HURON ST APT 2, CHICAGO, IL, 60610-3331, US

(21) Appl. No.: 11/901,306

(22) Filed: Sep. 18, 2007

Related U.S. Application Data
(60) Provisional application No. 60/845,445, filed on Sep. 18, 2006.

(51) Int. Cl. B62B 3/00

(52) U.S. Cl. 280/47.35; 280/79.3

(57) ABSTRACT

A portable caddy for storing items used to cleanse and care for a patient. The caddy includes a base frame supported on wheels and a support post rigidly attached to and extending upwardly from the base frame, A first metal wire basket receptacle shaped and sized to receive a urinal vessel is attached support post at a level at which the urinal is easily accessible to the patient when in bed. The caddy includes a second metal wire basket receptacle shaped and sized to receive a bedpan. A third receptacle shaped and sized to store a collection of disposable wipes is attached to said post at a level where the wipes can be easily reached by either the patient or the nursing staff. The caddy also carries a metal wire basket for holding ointments, sprays and the like used to cleanse the patient. An additional smaller wire basket is provided for the storage of personal hand wipes. A wire basket wastebasket is attached to the base on one side of the caddy to receive disposable wipes after they are used. One or more of the wire basket receptacles, particularly those used to hold the urinal and the bedpan, as well as the wastebasket, may be lined with an opaque disposable liner. There is a wire cradle-type storage tray for the disposable liners fixed to the base, on the opposite side of the caddy, beneath the bedpan storage receptacle.

### CROSS REFERENCE TO RELATED APPLICATIONS

This application is a non-provisional of and claims the benefit of the filing date of Provisional Patent Application Ser. No. 60/845,445 filed on Sep. 18, 2006, the disclosure of which is incorporated herein by reference.

### FIELD OF THE INVENTION

This invention relates to a storage system or “caddy” for conveniently storing items frequently needed to properly care for a bedbound patient.

### BACKGROUND OF THE INVENTION

In patient's rooms in a hospital or nursing facility, there is typically no “home” designated for urinals or bedpans. They are initially issued to a patient in a clean and sanitary condition, and thereafter typically kept in or on the patient's bedside table. Once these articles are used, they are often not kept clean, and are neither attractive nor healthy.

This problem has become more acute in these times of nursing and caregiver shortages. Hospitals routinely hire personnel who may be poorly trained and have neither the time nor the motivation to attend to toileting articles or, to cleanse an incontinent patient properly. Because nurses and aides must often work under severe time constraints, it is very important that the time that can be spent on behalf of a patient be as productive as possible.

### SUMMARY OF THE INVENTION

The preferred embodiment of the invention takes the form of a portable storage system for conveniently storing personal toileting supplies needed to care for a bedbound patient.

Several staggered, metal wire basket-type receptacles, each of which is shaped and sized to receive commonly needed toileting supplies, are supported on vertical pole which extends upwardly from a rolling base. In its preferred form, the storage system includes receptacles that hold a urinal, a bedpan, disposable wipes, cleansing soaps and/or creams, and personal hand wipes. The storage unit further includes a waste basket to receive the refuse generated during patient care, and a tray to hold a roll of disposable opaque liners that are placed in the receptacles and that can be easily replaced if they become soiled. The rolling base upon which the storage system is mounted preferably includes at least one locking wheel.

The wheeled base can be easily rolled and positioned next to a bed or a chair, or stored in the corner for nighttime use only. The system can also be easily moved into a bathroom so that the items in the storage system are available there, and so that the urinal may be more conveniently emptied. The vertical organization of the system minimizes the floor space needed and facilitates positioning of the receptacles at a vertical level where they can be easily reached by both patient and the nursing staff.

It is a leading object of the invention to improve the quality of patient care by making items needed when care is being provided conveniently accessible in a consistent way to the health care worker and/or to the bedridden patient.

Of particular importance, the storage unit includes a basket with an opaque disposable plastic liner for holding a urinal. This provides a secure place for the male patient to store his urinal (away from his eating area) and provides dignity to the patient by obscuring the sight of his urinal from visitors. Urinals are now commonly placed on bedside tables and represent a significant health risk which can be largely eliminated by providing a sanitary storage location for the urinal after it has been used.

The preferred embodiment of invention further includes a wire basket type receptacle with a removable opaque liner for holding a patient's bedpan. As in the case of the urinal, there is typically no place to conveniently store a bedpan where it can be easily located and used, yet be kept largely out of view in a sanitary location when not in use. Under common practices today, because bedpans have no designated storage location in a patient's room, they often travel around the patient's room or the bathroom, resting on side rails, wastebaskets, shower chairs, etc. Since bedpans have no true “home,” once they are contaminated there is a significant risk that they can be accidentally switched between patients, vastly increasing the possibility of transferring contagious disease.

Convenient storage is also provided for disposable wipes. When an incontinent patient is being attended to, the nursing staff routinely needs quick access to disposable wipes, yet there is typically no place in any patient's room that is designated to store wipes, let alone a convenient location near to the patient. One receptacle is used to hold personal hand wipes, and is positioned for easy access by a bedridden patient, allowing patients to cleanse their hands after toileting and protecting their dignity.

After the disposable wipes are used by a patient or the nursing staff, there is typically no conveniently located wastebasket or other receptacle available to simplify their disposal. The invention solves this problem as well by including a lined wastebasket as part of the portable storage system which can be moved to the location where the patient is being attended to.

Proper perineal care of a patient commonly requires the administration of topical creams or sprays, yet these creams or sprays are commonly not utilized because they are not easy to find, again because they are given no consistent “home” in the patient's room. In the preferred embodiment of the invention, a receptacle for storing the needed creams and sprays is provided where they are easy to find and easy to use, along with the hand wipes and towelettes that are commonly needed at the same time.

The use of opaque disposable plastic liners for some or all of the receptacles in the storage unit, particularly the receptacles for the urinal and the bedpan and the wastebasket that receives disposable wipes after use, makes the presence of the items being held less unsightly and provides a convenient, sanitary way that these items to be removed from the storage receptacle for disposal and/or cleaning, while preventing the storage unit itself from being contaminated.

These and other objects, features and advantages of the present invention may be better understood by considering the following detailed description of a preferred embodiment of the invention which is presented with the attached drawing.

### BRIEF DESCRIPTION OF THE DRAWING

In the detailed description which follows, frequent reference will be made to the attached drawings, in which:

FIG. 1 is a perspective view of a preferred storage system that utilizes the invention.

### DETAILED DESCRIPTION

The preferred embodiment of the invention comprises a collection of wire/metal basket-type containers whose shapes and sizes are adapted to receive and hold various items needed to toilet a bedbound patient.

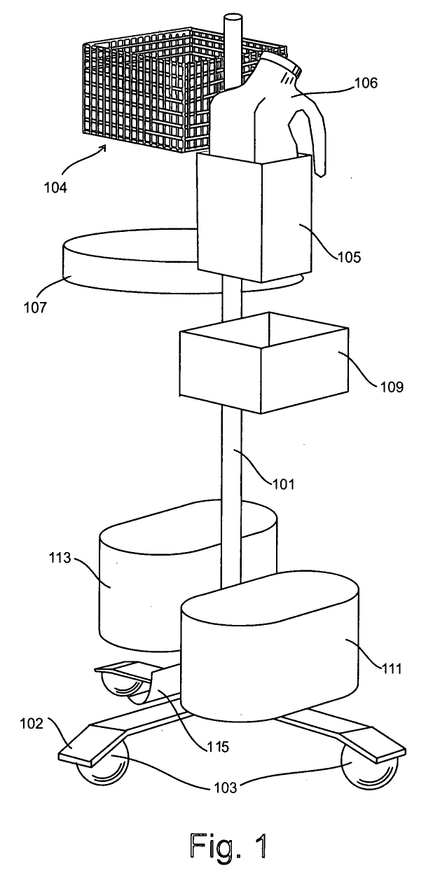

As seen in FIG. 1, these containers are attached to and supported by a metal pole 101 which is rigidly attached to and extends upward from a rolling, crossfooted base 102. The base consists of an X-shaped base which includes a socket (not shown) for receiving and supporting the pole 101. A wheel or ball roller is attached to underside of each of the four extended arms of the X-shaped base as illustrated at 103. At least one of these wheels or rollers preferable includes a locking mechanism to prevent the wheel from rolling, thereby securing the storage unit at a desired location on the floor. The X-shaped rolling support and the vertical support pole may be the same or similar to the movable intravenous (I.V.) support poles that are currently in common use in hospitals.

A collection of individual containers (shelves and receptacles) are attached to the vertical support pole 101 on two sides. To simplify the drawing and to more clearly indicate the general shape, size and position of a preferred set of containers, each container shown in FIG. 1 except the uppermost container 104, is shown as if formed from solid panels. In practice, however, each of these containers preferably takes the form of a metal wire basket (illustrated in FIG. 1 for the container 104) constructed from stainless steel or chrome-plated wire. Such baskets are widely used in a variety of hospital storage applications because they are strong, light weight, and tend to be “self cleaning: since they do not collect dirt, liquid from spills, or other debris as would containers constructed from solid panels.

Some or all of the basket containers may advantageously be lined with a discardable plastic bag liner that keeps the basket clean and facilitates the disposal or removal of the contents of the lined receptacle. The liners are particularly useful for lining those receptacles (described below) that hold the urinal, the bedpan and the wastebasket. These liners are commonly packed in convenient dispenser cartons or sold in rolls with each liner separated by the next by a perforated seam that allows a liner to be easily removed from the roll. When a wire basket is used, opaque liners hide the contents (such as a filled urinal) from sight.

Each container is rigidly attached to the support pole 101, for example by welding the wires of the wire baskets to the support pole, and in some instances, to each other at various points of contact. Alternatively, some or all of the wire baskets may be fitted with a bracket that includes a releasable clamp for removably attaching the basket to the vertical pole. Such a clamp may be tightened using a hand-turned knob or wing-nut to secure it to the vertical pole 101, and may be loosened to permit each basket to be moved vertically and positioned at a desired level where the bracket is again tightened to secure the basket in place.

In its preferred form, the storage unit provides individual shelves or receptacles for conveniently storing the following items that are commonly used in the care of a bedridden patient:

A wire/metal basket receptacle seen at 104 is attached to the support pole 101 at the top of the storage unit. The receptacle 104 provides storage for disposable cleansing wipes commonly used for perineal care. These cleansing wipes are approximately 5×7 inches. These larger cleansing wipes are commonly used for general cleansing of the incontinent patient, or cleansing the perineal area during routine toileting.

A wire basket receptacle 105 for receiving a patient bedside urinal 106 (a urine receiving bottle typically constructed of translucent plastic which includes a handle and a cover, and which is commonly graduated in cc's and/or ounces to indicate the volume of urine contained). The receptacle 105 should have an adequate cross-sectional area (about 6×6 inches) to accommodate all commonly available urinals, which typically hold up to about 1,000 cc of fluid. The sidewalls of the urinal receptacle 105 extend upwardly by a sufficient distance to securely retain the urinal and obscure its contents, yet permit it to be easily grasped by its handle and removed from the receptacle.

A wire-metal half-round basket/shelf seen at 107 extends outwardly from the base of, and is secured by, the receptacle 105. This shelf is intended to hold cleansing sprays, topical creams used in perineal care, and the like, thereby providing quick and convenient access to items that, under current practices, are under-utilized because they typically have no “home” and would require too much time to find, retrieve and use.

A wire-metal basket/tray 109 for storing disposable hand wipes or “towelettes.” Hand-wipes are pre-moistened, typically with a benzalkonium chloride solution that provides both an antiseptic and bactericidal cleansing action, are either individually packaged, or a small number of towelettes is packaged together, in a moisture tight container to reduce evaporation prior to use. These hand-wipes can provide quick, antiseptic cleansing for patients and the attending medical staff, and making them easily available at a convenient, consistent location promotes their frequent use. The receptacle 109 for the disposable hand wipes is attached to the vertical pole 101 and positioned below the urinal receptacle 105.

A wire-metal wastebasket basket 111 attached at the bottom of the pole, resting on the cross-footed base 102. The wastebasket is included to provide a convenient location for used wipes and towelettes, and discarded receptacle liners.

A wire-metal basket 113 sized to receive and hold a bedpan is staggered above the wastebasket 111, on the opposite side of the pole 101, and above the half round wire plastic bag cradle 115.

In the storage arrangement seen in FIG. 1, the half-round wire rack for holding a roll of opaque plastic liners is attached at the base of the storage unit as seen at 115. The liner holder 115 rests on the X-shaped base frame 102 and is secured to the bedpan receptacle 113 and the wastebasket 111.

The preferred embodiment of the invention described above provides a convenient portable storage location for the items commonly used to care for a bedridden patient who is unable to use the bathroom. Urinals and bedpans are stored where they can be easily accessed from and returned to a sanitary location where they are less unsightly and less likely to contaminate their surroundings after use. Other commonly needed articles, such as hand wipes and cleansing wipes, ointments, cleansing sprays and the like, are made readily available when needed. The invention eliminates the prevalent problem that there is typically no place in a patient's room for storing urinals, bedpans, towelettes and hand wipes, other articles needed during patient care, and no convenient place to dispose of used towelettes and wipes.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A system for storing items used in caring for a bedridden patient comprising, in combination,
a wheeled support frame for supporting a plurality of receptacles including at least:
a first receptacle for holding a urinal vessel,
a second receptacle for holding a bedpan,
a third receptacle for holding large disposable wipes
a fourth receptacle for holding personal hand wipes, and
a wastebasket.

2. A system for storing items used in caring for a bedridden patient as set forth in claim 1 further including a fifth receptacle for storing ointments or creams for treating said patient.

3. A system for storing items used in caring for a bedridden patient as set forth in claim 1 further including disposable liners for one or more of said receptacles.

4. A system for storing items used in caring for a bedridden patient as set forth in claim 3 further including a receptacle for storing a supply of said disposable liners.

5. A system for storing items used in caring for a bedridden patient as set forth in claim 1 wherein at least said first and second receptacles are wire baskets.

6. A method for caring for a bedbound patient comprising, in combination, the steps of:
providing a wheeled transport that supports and carries a plurality of receptacles and a wastebasket,
storing a urinal vessel in a first of said receptacles,
storing a bedpan in a second of said receptacles,
storing a collection of disposable wipes in a third of said receptacles,
moving said wheeled transport to a location near said bedbound patient,
using said wipes from the third of said receptacles to cleanse said patient, and
discarding used wipes in said wastebasket.

7. A method for caring for a bedbound patient as set forth in claim 6 wherein said wheeled transport comprises a base frame supported on wheels and a support member that extends upwardly from said frame to which receptacles are attached.

8. A method for caring for a bedbound patient as set forth in claim 6 wherein each of said receptacles and said wastebasket is a wire basket.

9. A method for caring for a bedbound patient as set forth in claim 6 wherein at least said first and the second of said receptacles are each fitted with a disposable opaque liner.

10. A method for caring for a bedbound patient as set forth in claim 8 wherein at least said first and second of said receptacles are each fitted with a disposable opaque liner.

11. A portable caddy for storing items used to cleanse and care for a bed bound patient, said caddy comprising, in combination:
a base frame supported on wheels,
an support post rigidly attached to and extending upwardly from said base frame,
a first receptacle shaped and sized to receive a urinal vessel attached to said post at a level that is accessible to said bed bound patient,
a second receptacle shaped and sized to receive a bedpan attached to said post or base frame, and
a third receptacle shaped and sized to store a collection of disposable wipes attached to said post at a vertical level accessible to said bed bound patient.

12. A portable caddy for storing items used to cleanse and care for a bed bound patient as set forth in claim 11 further including a wastebasket attached to said base frame or said support post for receiving said disposable wipes after they are used.

13. A portable caddy for storing items used to cleanse and care for a bed bound patient as set forth in claim 11 wherein said receptacles are open mesh baskets.

14. A portable caddy for storing items used to cleanse and care for a bed bound patient as set forth in claim 13 wherein said open mesh baskets are formed from metal wire.

15. A portable caddy for storing items used to cleanse and care for a bed bound patient as set forth in claim 11 further including a fourth receptacle attached to said post or base frame for storing a collection of disposable liners adapted to be inserted into one or more of said first, second or third receptacles.
